(19) United States
(12) Patent Application Publication
(10) Pub. No.: US 2016/0127294 A1
(43) Pub. Date: May 5, 2016

(54) Method and Apparatus for Location Related Social Reminder Provision

(71) Applicant: Ford Global Technologies, LLC, Dearborn, MI (US)

(72) Inventors: Kwaku O. Prakah-Asante, Commerce Township, MI (US); Hsin-hsiang Yang, Ann Arbor, MI (US); Fling Tseng, Ann Arbor, MI (US)

(21) Appl. No.: 14/529,931

(22) Filed: Oct. 31, 2014

(51) Int. Cl. H04L 12/58; G06N 5/02

(52) U.S. Cl. CPC H04L 51/20; G06N 5/022; G06Q 50/01

(57) ABSTRACT

A system includes a processor configured to determine a vehicle destination. The processor is also configured to access a driver-owned media delivery account to determine context-relevant information relating to the destination. The processor is further configured to prepare a driver alert based on the context-relevant information and deliver the driver alert.

### TECHNICAL FIELD

The illustrative embodiments generally relate to a method and apparatus for location related social reminder provision.

### BACKGROUND

Vehicle connected services provide many different varieties of advanced driver awareness in modern automotive computing systems. Drivers can receive on-the-go navigation, text and email updates. Phone calls can be handled in a hands-free manner by vehicles as well. Through the interconnectivity, drivers have become accustomed to having access to remote-connected services while driving. Of course, access to many services requires significant driver attention, and it is not advisable for a driver, for example, to be reading social media updates while en-route.

Advertisements may be selected for output on a mobile (e.g., vehicle navigation) system based on contextual data, including current state data from a location-sensing (e.g., GPS) device. The advertisement may be an image displayed at a location on a map corresponding to a physical location of the advertiser. The contextual data may include location, direction and destination data, user preference data and user-provided data such as calendar, task and/or contacts data. Examples of other contextual data include age, gender, number of vehicle occupants, vehicle make, vehicle model, and/or vehicle style. The user may interact with the advertisement, e.g., to communicate an order for a product or service corresponding to the advertisement.

Collection of information about a user's activities and habits on an ongoing basis with the user's permission can be tied to inferences that enable predictions about the user's preferences. As a result, when it comes time for the user to make a decision or a selection, information about past history and permissible inferences can be used to automatically provide suggestions for implementing future activities. In addition, in some cases this previous history information can be used to optimize future selections.

### SUMMARY

In a first illustrative embodiment, a system includes a processor configured to determine a vehicle destination. The processor is also configured to access a driver-owned media delivery account to determine context-relevant information relating to the destination. The processor is further configured to prepare a driver alert based on the context-relevant information and deliver the driver alert.

In a second illustrative embodiment, a computer-implemented method includes determining a vehicle destination. The method also includes accessing an occupant-owned media delivery account to determine, via a computing system, context-relevant information relating to the destination. The method further includes preparing a driver alert based on the context-relevant information and delivering the driver alert.

In a third illustrative embodiment, a non-transitory computer-readable storage medium, stores instructions that, when executed by a processor, cause the processor to perform a method including determining a vehicle destination. The method also includes accessing a driver-owned media delivery account to determine context-relevant information relating to the destination. Further, the method includes preparing a driver alert based on the context-relevant information and delivering the driver alert.

### BRIEF DESCRIPTION OF THE DRAWINGS

FIG. 1 shows an illustrative vehicle computing system;

FIG. 2 shows an illustrative example of a driver-location and information awareness system;

FIG. 3 shows an illustrative process for location-based information retrieval;

FIG. 4 shows an illustrative process for account to destination correlation; and

FIG. 5 shows a process for dynamic destination-information reminders.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

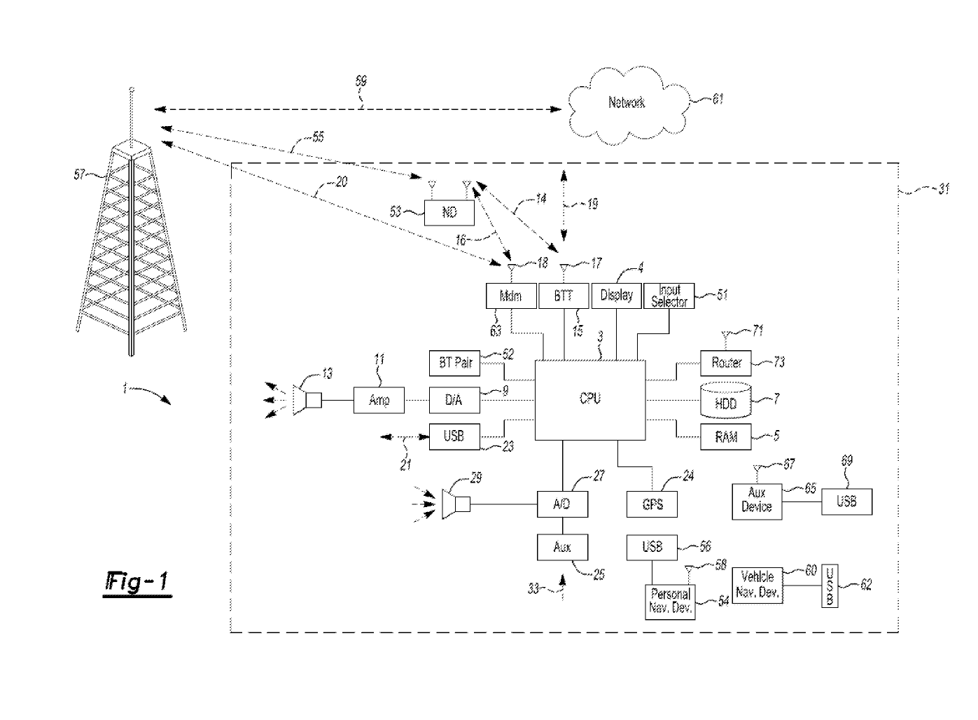

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

In the illustrative embodiments, drivers are provided connectivity and infotainment to enhance the driving experience. While en-route, information related to destinations (school, work, kids school, stores, restaurant) may become available on e-mail, text messages, social media or other connected messaging systems. Relevant data information may not be apparent, or appropriate to retrieve during the drive (due to levels of distraction associated with accessing certain remote features).

Awareness of social relevant information just before the drive cycle is also useful. For example a parent not yet aware of a school closing may be reminded. In another situation, a coupon for a restaurant or store being driven to may not have been assessed. The illustrative embodiments provide an in-vehicle application or an application on a brought-in device customized to present more relevant information pertaining to the drive for customers would be of value.

The illustrative embodiments provide an Intelligent Social Awareness En Route (ISA) system in a connected vehicle/brought-in app to provide driver relevant information on their social networks pertaining to a destination or nearby location. The ISA En Route provides appropriate relevant information at appropriate time and that are safe and/or convenient to the driver. Internet based information, vehicle, driver and environment sensing and connectivity data may be incorporated and the recommendations may be send via vehicle display. The driver may also be allowed an option to provide key words for routine extraction for presentation during the drive.

Components of an illustrative system include, but are not limited to, intelligent information extraction, date and time segment category, route and stopping locations prediction and driver display and interaction. The ISA system provides relevant information en route to improve driver convenience and personalization.

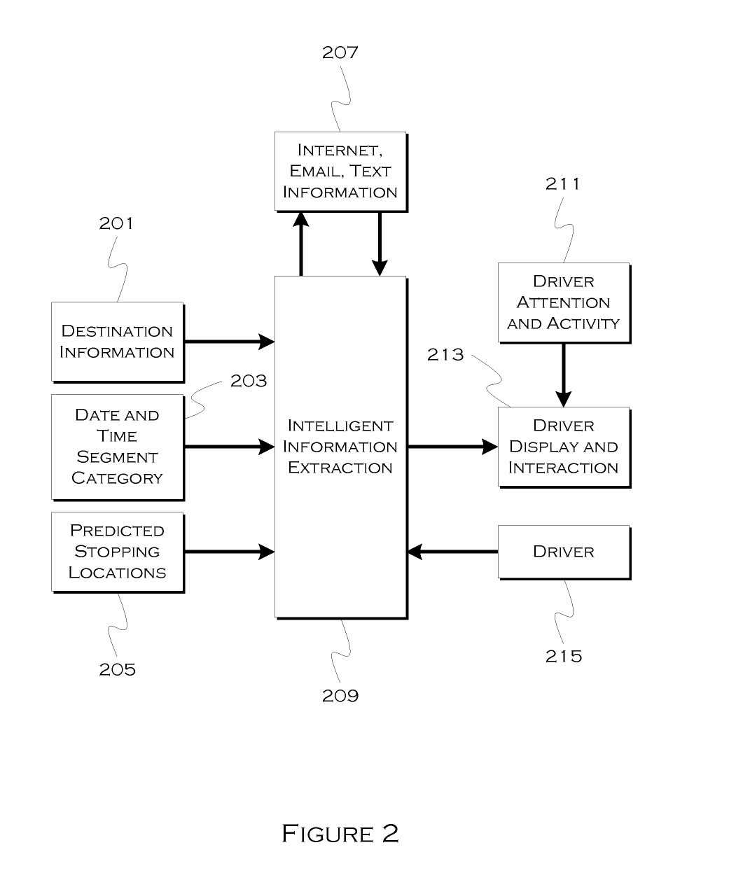

FIG. 2 shows an illustrative example of a driver-location and information awareness system. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

This illustrative example shows a block diagram of the sub-systems for an Intelligent Social Awareness En Route (ISA) system. The ISA consists of an Intelligent Information Extraction subsystem (IIE), which explores and scans e-mail, tweets and allowed social content information related to the driver preferences for connected systems. The IIE system may use various key word data scanning methods including Bayesian analysis, and neural-networks. In operational mode, the ISA system obtains information from the vehicle, driver and environment sensing, internet, and connectivity data for information processing. The outputs from the IIE are sent to the Driver Display and Interaction system (DDI). The driver is alerted to key information or read to the driver at the right time by the DDI when the driver driving activity is not high.

The Intelligent Social Awareness En Route therefore presents the system and means in a connected vehicle/brought-in app to provide the driver relevant information from driver social information sources pertaining to the drive destination, points of interest and likely stopping points or destinations. Driver social information sources can include, but are not limited to, text messages, email, social networks, and other updateable information repositories.

Inputs to the system include destination information 201, date/time information 203 and predicted stopping locations. For example, a driver may have pre-programmed one or more destinations into the route location system prior to reaching a destination. This information can be used in conjunction with the social data inputs 207 to determine information that may be relevant to the driver relating to the destination.

For example, without limitation, a school may be closed for a snow-day, and an email, text or other social update may have been delivered to the driver at some point prior to or during the drive. Often times, this information may be date/time relevant, so the information may be much more useful if delivered with respect to the appropriate date/time. Predicted stopping locations may also be useful in determining non-entered destinations which may lie along a route. These may be, for example, destinations which a driver frequently visits. For example, a gas station commonly visited by a driver may issue an email coupon with an expiration date of five days hence.

Using the examples discussed above, if a snow day was on Monday, and the coupon issued on Monday, a parent driving a child to school on Monday morning might trigger two events. If the destination “school” had the snow day associated with it, via information provided through a media delivery medium 207 (e.g., without limitation, text, email, social network, etc.), the day/date (Monday) in conjunction with the destination might result in the retrieval of the school closing and delivery of this information to the parent/driver. Also, if the vehicle passed within a predefined proximity to the gas station, the gas coupon might be retrieved and delivered, since the gas station was known as a frequent stopping point.

On Tuesday-Friday of that same week, the gas coupon would still be eligible for delivery if still available (e.g., not redeemed), but the school closing information would not be delivered, since its applicable date had already expired. Accordingly, date/time information is useful in conjunction with the destination information, because it can help sort out which destination-related information is appropriate for delivery. Further, the following week, neither piece of information would be delivered, since, in the example above, the school-closing was only applicable to Monday of the previous week and the coupon expired on Friday of the previous week.

In the example above, the gas station is an example of a predicted stopping location 205. Either because of, for example, a low fuel state or because a user frequently visits a location, the system may predict some likelihood of a user stopping at the location. For example, the system may historically show that a user within five miles of a certain restaurant around meal times will typically visit that restaurant. Thus, in the instances where a user is within five miles of the restaurant, and it is around a meal time (which can be specified by predefined parameters based on input and/or observed behavior), the system may assume the restaurant is a “likely stopping point” and retrieve any information that may be useful to a driver stopping at that restaurant.

The media content delivery systems from which information can be pulled include email, text, social media (e.g., facebook, twitter) and any other digital content delivery source that can be accessed by the vehicle. The vehicle can be provided with access rights to these accounts, and can use keywords (e.g., without limitation, destination name, destination address, destination type, date, time, etc.) to search data in these accounts utilizing advanced searching techniques. Relevant information can be stripped from these accounts and delivered to a driver when and if appropriate.

The intelligent information extraction system 209 brings together the context information from the contextual systems 201, 203, 205 and any other contextual systems (traffic, environmental, etc. that may be used in determining information from the media delivery accounts, as well as accesses the media delivery accounts for the relevant information.

The relevant information will be displayed to a driver at an appropriate time. For example, with respect to destination-related materials, the information might be displayed as soon as available, since the system definitively “knows” that the driver is headed to that destination. On the other hand, with respect to likely stopping points or destinations, the information might be reserved until the vehicle is within some proximity to the destination, since the likelihood of stopping is based on a “guess.” In other scenarios, however, information even related to likelihood-type locations might be delivered immediately, since it may affect the likelihood of a stop (e.g., the existence of a coupon might make the stop more likely). Or, for example, the decision of when to deliver the information might depend on either the type of information and/or the projected likelihood of a stop (projectable from observed behavior).

Information also may be delayed for delivery until such time as a driver attention load is not occupied by actual driving. To this end, the system draws information from a driver attention and activity monitoring module 211. Once the system has determined that it is safe to deliver the information, the information may be delivered via a display 213 and the driver 215 can perform any needed interaction with the delivered information (confirmations, coupon selection, etc.).

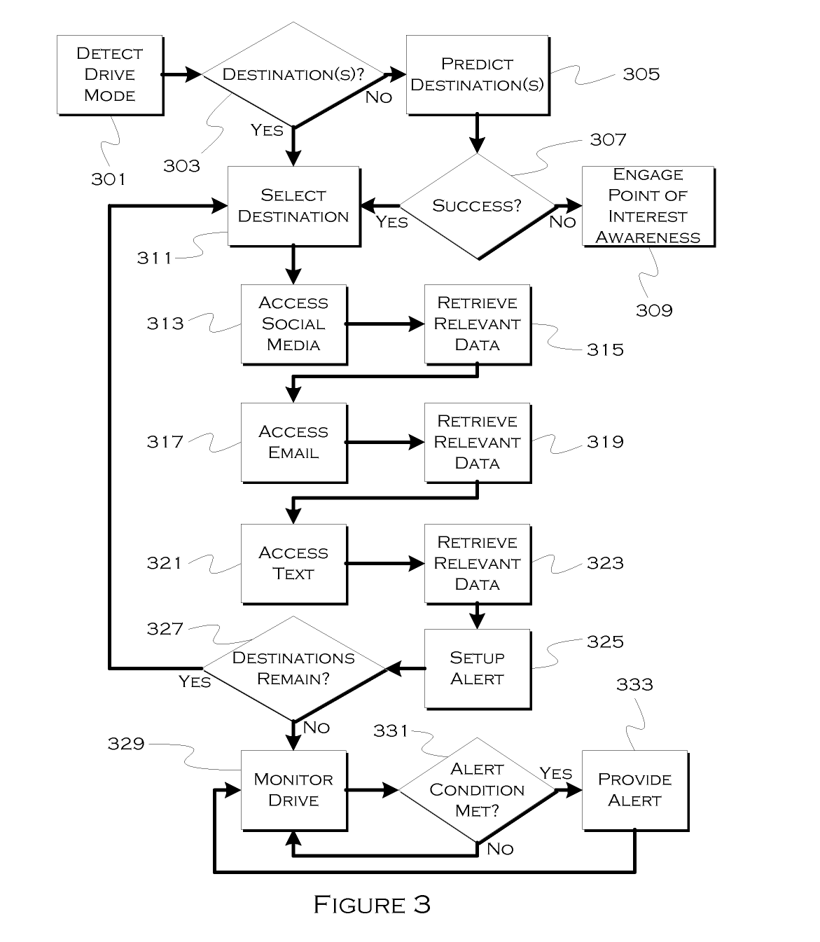

FIG. 3 shows an illustrative process for location-based information retrieval. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process detects that the vehicle is in a drive mode 301. This could include a vehicle actually in motion, or could merely be a vehicle startup indicating a drive is about to begin. Once the drive mode is detected, the process may check for any input destinations 303. Since destinations may be input at a future time during the drive, this check could be repeated, for example, following any interaction with the navigation system, new destination input, etc. (to capture newly input destinations).

If there are no destinations currently input, the process could attempt to predict one or more destinations using known techniques for destination prediction 305. This could include, but is not limited to, predictions based on time of day, day of week, current location, etc. If there are one or more predictable destinations 307, or if one or more destinations has already been input 303, the process can select at least one destination 311 for processing. If the system was unable to predict any destinations, based on, for example, lack of historical data, the process may engage a point of interest (POI) awareness routine 309, that can observe points of interest along a traveled route and pull any relevant data as appropriate.

Once a destination has been selected, the process can access one or more social media accounts (e.g., without limitation, FACEBOOK, MYSPACE, TWITTER, etc.) 313 and retrieve any relevant data, using the destination and any context data (time, date, day, environment, etc.) 315. Using keyword and known search techniques, the process can scour recent social media updates, for example, to see if any information relating to a known or predicted destination is present. Similar access can be performed for emails 317 and text messages 321, and relevant email data 319 and text data 323 can be retrieved from each.

If any information appears to be relevant and appropriate for delivery, based on predefined criteria for delivery (e.g., without limitation, destination match, time of day match, date match, day of week match, etc.), an alert can be setup for delivery of this information 325. If the information is not immediately delivered, the alert can set the appropriate state for delivery (e.g., without limitation, driver distraction below threshold, vehicle in proximity to location, time of day appropriate, etc.). This process can be repeated for all destinations until no destinations remain 327.

Once any appropriate alerts have been determined and set, and no further destinations remain for processing 327, the system will monitor the drive (drive states, distraction states, locations, etc.) 329 and determine if any alert conditions are met 331. If an alert condition is met, the process will deliver the corresponding alert to the driver 333.

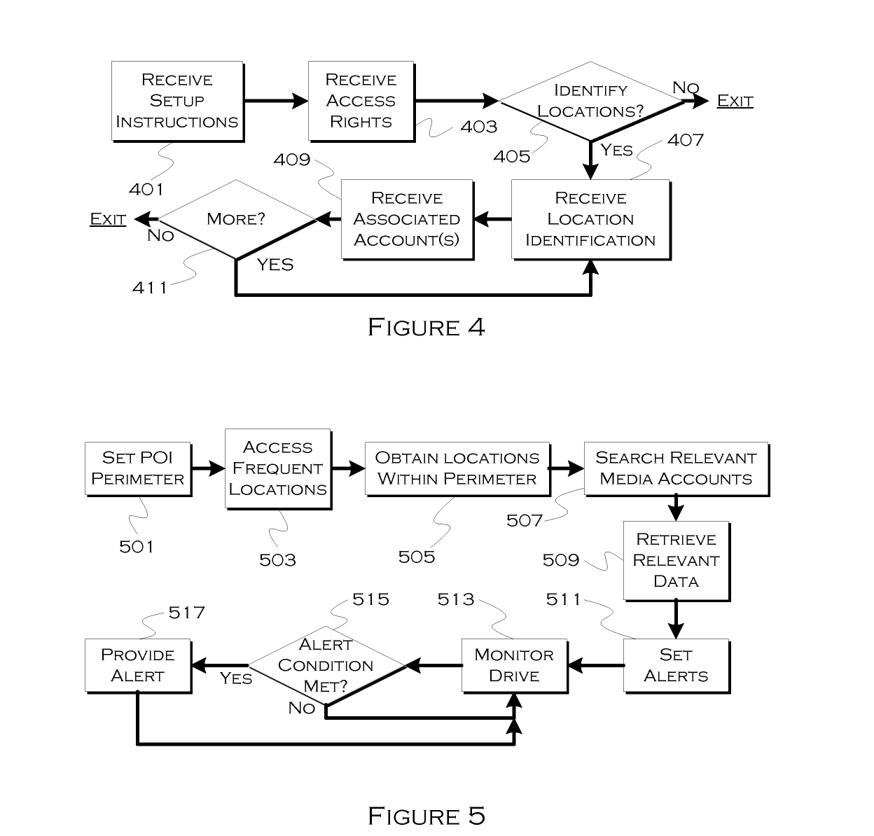

FIG. 4 shows an illustrative process for account to destination correlation. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a user sets up an application account so that the application for determining context relevant destination information can access the appropriate media delivery accounts. The process receives an identification of each relevant account 401 (e.g., without limitation, email address, text phone number or account access site, social media site identifiers, etc.). For each identified account, if needed, access rights are also provided 403. For example, without limitation, for an email or social media account, login and password information may be needed. On the other hand, a vehicle may already have access to the text messages of any connected phone, so the vehicle may merely need a phone number to identify which text message account to be used for a given driver.

In this example, the occupant setting up the account also has the opportunity to affiliate any specific locations for an account 405. For example, it may be the case that the driver will only receive email updates relating to school closings, and that text and social media are irrelevant for this item. Accordingly, the driver may choose to affiliate a school location with the email account only. In other examples, all accounts may have a chance to receive relevant information, and thus none will be specifically affiliated (indicating that all should be checked for context-relevant information).

For any context-relevant accounts, the process will receive a location identification 407. This identification can be a name, address or any other identifier that the process can use when identifying the location and/or searching for context relevant information. Then, with respect to this location identifier, the process may receive one or more indications of accounts to be affiliated with this particular location 409. If additional locations need specific account affiliation 411, the process can continue until all locations have appropriate accounts associated therewith.

FIG. 5 shows a process for dynamic destination-information reminders. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a context-relevant information presentation process is performed with respect to relevant points of interest (POIs). This process can be run in conjunction with a destination-oriented process, or, for example, can be run if no destinations can be found or predicted.

In this illustrative embodiment, a perimeter may be set around the vehicle, the route (or projected route) and/or around any number of POIs. In this example, the perimeter is set around a vehicle 501. The process accesses frequent locations visited by the user 503, to see if any of these locations correspond to locations within the perimeter around the vehicle. Using the example previously given, relating to the school destination and the gas station optional-destination, the process, a perimeter of five miles may be set around the vehicle. The gas station is identified as a location that the user frequents, and once the vehicle comes within five miles of the gas station the gas station is identified as a possible stopping location within the perimeter 505.

For each location so-identified, the process searches any appropriate media delivery accounts 507 and obtains appropriate context-relevant information 509. As with the destination oriented process, the system may set alerts and/or alert conditions associated with the relevant data 511. The drive is then monitored 513 and, if any alert conditions are met 515, the process delivers the appropriate alerts 517. If the POI is passed without the conditions (proximity, time, etc.) being met, the process may simply ignore the alert.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
determine a vehicle destination;
access a driver-owned media delivery account to determine context-relevant information relating to the vehicle destination;
prepare a driver alert based on the context-relevant information; and
deliver the driver alert.

2. The system of claim 1, wherein the processor is configured to determine the context-relevant information based on text of media delivered to the driver-owned media delivery account.

3. The system of claim 1, wherein the vehicle destination is predicted based on observed driver behavior.

4. The system of claim 1, wherein the vehicle destination corresponds to a point of interest within a predefined proximity to a current vehicle location.

5. The system of claim 1, wherein the driver-owned media delivery account includes a text message account.

6. The system of claim 1, wherein the driver-owned media delivery account includes an email account.

7. The system of claim 1, wherein the driver-owned media delivery account includes a social networking account.

8. The system of claim 1, wherein the driver alert is delivered based at least on a meeting of one condition specified in the driver alert.

9. The system of claim 1, wherein context utilized for determining the context-relevant information includes time of day, day of week, or date information.

10. The system of claim 1, wherein context utilized for determining the context-relevant information includes environmental information.

11. A computer-implemented method comprising:
determining a vehicle destination;
accessing an occupant-owned media delivery account to determine, via a computing system, context-relevant information relating to the destination;
preparing a driver alert based on the context-relevant information; and
delivering the driver alert.

12. The method of claim 11, wherein the occupant-owned media delivery account is a driver-owned media delivery account.

13. The method of claim 11, wherein the vehicle destination is predicted based on observed driver behavior.

14. The method of claim 11, wherein the vehicle destination corresponds to a point of interest within a predefined proximity to a current vehicle location.

15. The method of claim 11, wherein the driver-owned media delivery account includes a text message account.

16. The method of claim 11, wherein the driver-owned media delivery account includes an email account.

17. The method of claim 11, wherein the driver-owned media delivery account includes a social networking account.

18. The method of claim 11, wherein the driver alert is delivered based at least on a meeting of one condition specified in the driver alert.

19. A non-transitory computer-readable storage medium, storing instructions that, when executed by a processor, cause the processor to perform a method comprising:
determining a vehicle destination;
accessing a driver-owned media delivery account to determine context-relevant information relating to the destination;
preparing a driver alert based on the context-relevant information; and
delivering the driver alert.

20. The storage medium of claim 19, wherein the driver-owned media delivery account includes a text message account, an email account, or a social networking account.
